(19) United States
(12) Patent Application Publication
(10) Pub. No.: US 2006/0098348 A1
(43) Pub. Date: May 11, 2006

(54) Microactuator, head gimbal assembly and magnetic disk drive

(76) Inventors: Ming Gao Yao, Dongguan City (CN); Masashi Shiraishi, Kowloon (HK)

Correspondence Address: KENYON & KENYON LLP, RIVERPARK TOWERS, SUITE 600, 333 W. SAN CARLOS ST., SAN JOSE, CA, 95110, US

(21) Appl. No.: 11/260,744

(22) Filed: Oct. 26, 2005

Related U.S. Application Data
(62) Division of application No. 10/993,832, filed on Nov. 19, 2004.

(30) Foreign Application Priority Data
Feb. 5, 2004 (WO) PCT/CN04/00097

(51) Int. Cl. G11B 5/56

(52) U.S. Cl. 360/294.4

(57) ABSTRACT

A method and system for manufacture of a microactuator comprising a frame further including a base to connect with suspension and two moving arms to be connected parallel to said base, two piezoelectric elements to be respectively connected to said moving arm, and a slider height adjuster connecting with said moving arms to adjust the loading height of the slider.

### FIELD OF THE INVENTION

This invention relates to the micro-actuator, head gimbal assembly and hard disk drive art. Specifically, the present invention relates to the micro-actuator, head gimbal assembly and hard disk drive for a femto or lesser size magnetic head.

### BACKGROUND OF THE INVENTION

In the art today, different methods are used to improve the recording density of a hard disk drive. FIG. 1 shows a typical disk drive. A spindle motor 102 spins the disk 101 while a drive arm (head gimbal assembly) 104 driven by voice coil motors controls the head 103 flying above the disk. Typically, voice coil motors (VCM) have been used for controlling the drive arm motion across the magnetic hard disk, which is centered around the spindle motor. In the present art, microactuators are now being used to “fine-tune” the head placement because of the inherent tolerance (dynamic play) that exists in positioning a head by a VCM alone. This enables a smaller recordable track width, which in turn increases the density or the “tracks per inch” (TPI) value of the hard disk drive. Figure 1b is an exploded view of the aforementioned elements of FIG. 1a.

FIG. 2 provides an illustration of a microactuator as used in the art. As described in the published patent applications JP 2002-133803and 2002-074871, a slider 202 (containing a read/write magnetic head; not shown) is utilized for maintaining a prescribed flying height above the disk surface 101 (see FIG. 1). FIG. 2a shows a head gimbal assembly (HGA) with a “U” shape microactuator 206 and flexure 215. U-shaped microactuators may have two ceramic beams 203 with two piezoelectric stripes 208 on each side of the beams that are bonded at two points 204 of the slider 202 enabling the slider to have motion independent of the drive arm 104 (see FIG. 1). Baseplate 216 is attached to the hinge 214. FIG. 2b shows a view of the U-shape micro actuator coupled with the head slider 202. FIG. 2c shows a side view around microactuator 206. The suspension tongue 210 is attached to the suspension dimple 211. There is a parallel gap between the bottom of the microactuator and the suspension tongue. The microactuator is coupled to a suspension on each side of the microactuator frame with the help of three electric conductive balls 207 (e.g., gold ball or solder ball). Four conductive balls 205 (e.g., gold ball bonding or solder bump bonding) near in the slider's trailing edge electrically couple the magnetic head and the moving plate 212 of the suspension. The head slider is directly coupled with the moving plate 212. With expansion and contraction of the piezoelectric strip, the U-shape micro actuator 206 will deform. Consequently, this will enable the fine adjustments in positioning required of the magnetic head. FIG. 2d shows another illustration using a metal frame as a micro actuator. This micro-actuator includes a base part 213 to connect with suspension and two moving arms 203 to be connected parallel to the base part. Two piezoelectric stripes 208 are mounted along the outside of the moving arms 203 to facilitate fine adjustments in position of the slider.

With the rapid development of improvements in the disk drive industry, manufacturing cost becomes a very critical element. For a specific size wafer, cost is inversely proportional to quantity produced. Aside from reducing cost of production, the main consideration is reducing the size of the chips or the heads. In the current industry, the 30% size slider (pico-slider) is popular and the femto-slider (20%) is going on to mass production. In the near future, the industry may see in the introduction of a 15%, 10% or even a 5% slider. However, it is difficult to use the current U-shape micro actuator for a slider this small since the size (especially the thickness) does not match the current design requirements. Moreover, reducing the microactuator thickness to accommodate such smaller heads reduces the external shock performance of the device. Additionally, the manufacturing process for such a reduced thickness microactuator is very complicated and costly. Therefore, the industry requires a head gimbal assembly design with a uniform microactuator design that does not require any change in design during mass production in order to accommodate sliders of smaller size.

### BRIEF DESCRIPTION OF THE DRAWINGS

FIGS. 1 a-b shows a hard disk drive as in the prior art, including a head gimbal assembly.

FIG. 2 illustrates a microactuator as used in the art.

FIGS. 3 a-d show exploded and perspective views detailing an embodiment of the present invention.

FIGS. 4 a-d show exploded and perspective views detailing an embodiment of the present invention.

FIGS. 5 a-d show exploded and perspective views detailing an embodiment of present invention.

FIGS. 6 a-c show exploded and perspective views detailing an embodiment of present invention.

FIGS. 7 a-c show exploded and perspective views detailing an embodiment of present invention.

FIG. 8 shows a flowchart detailing one method of manufacturing an embodiment of the present invention.

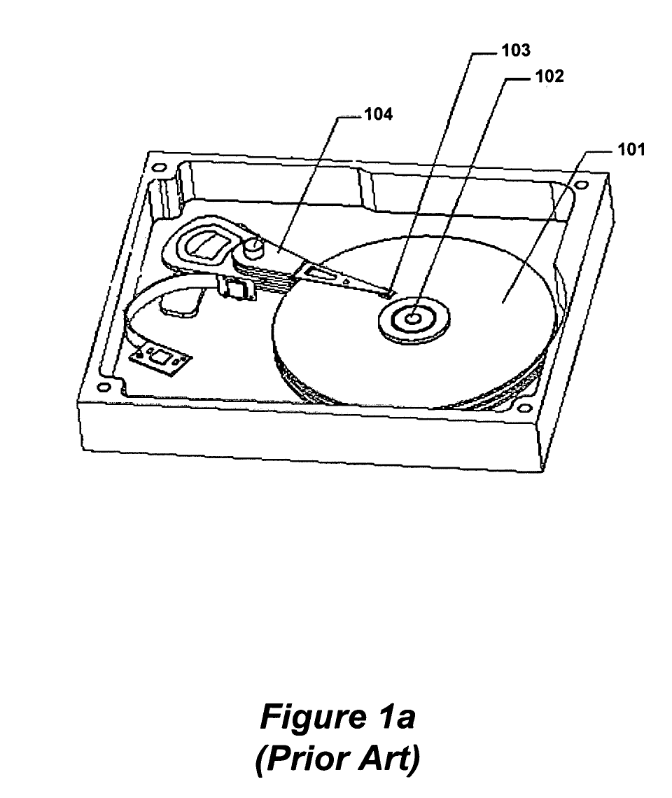

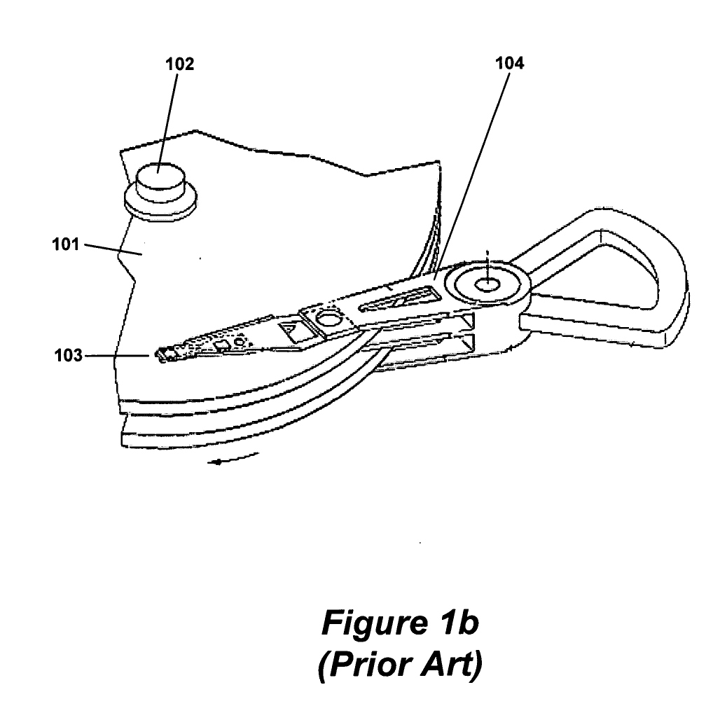

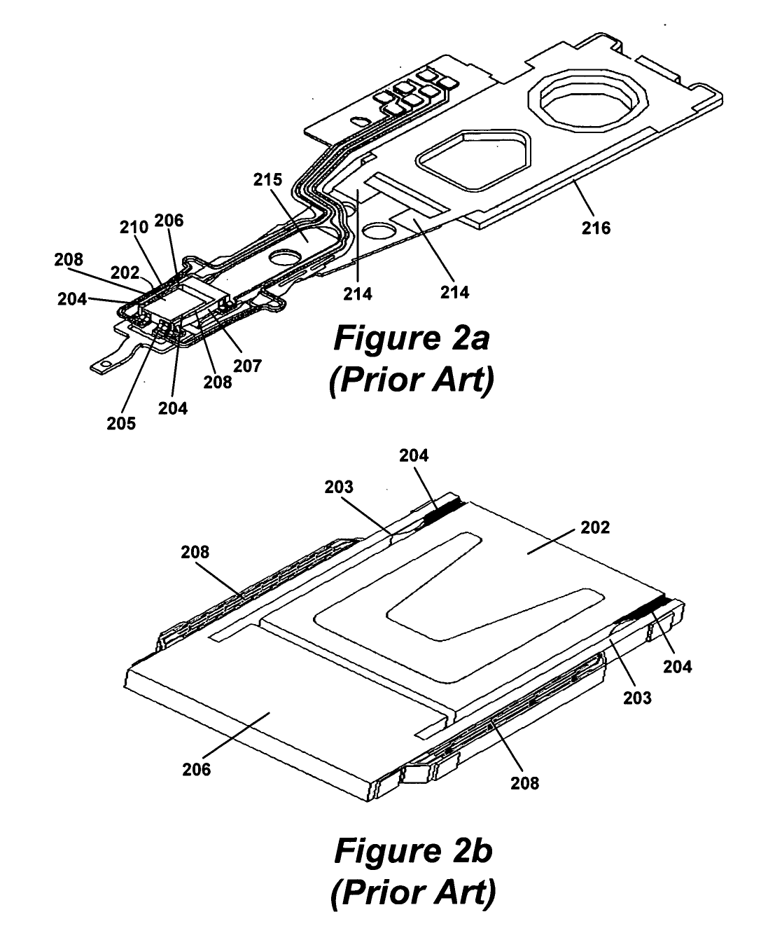

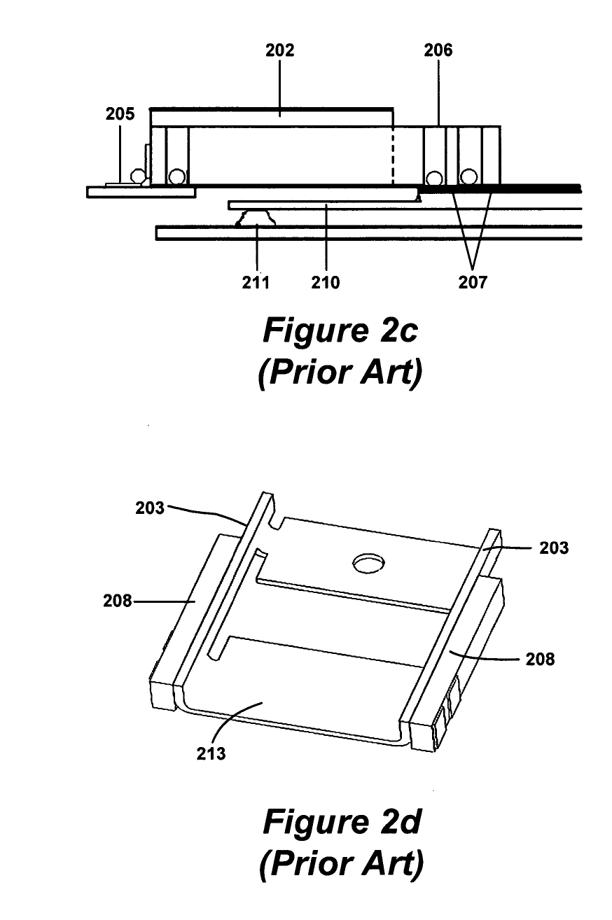

### DETAILED DESCRIPTION

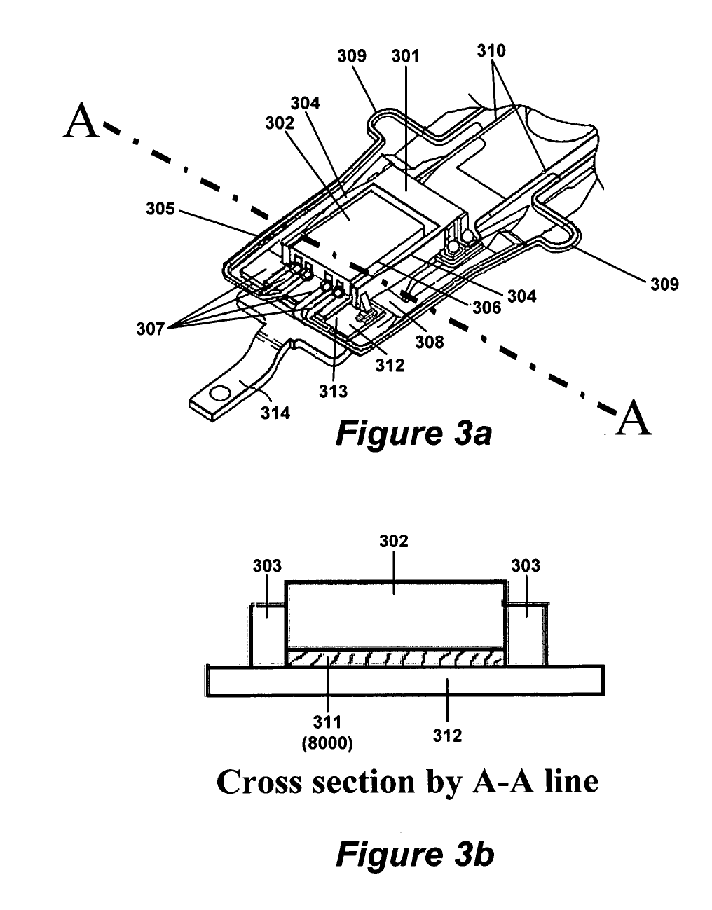

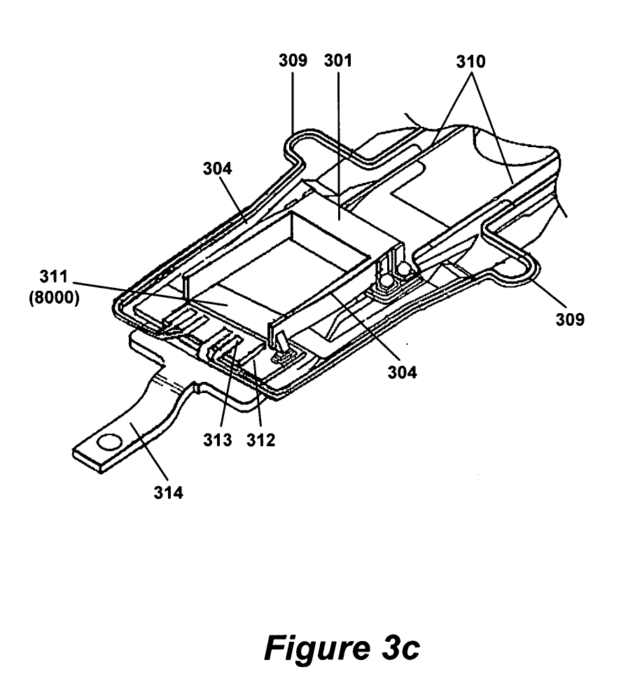

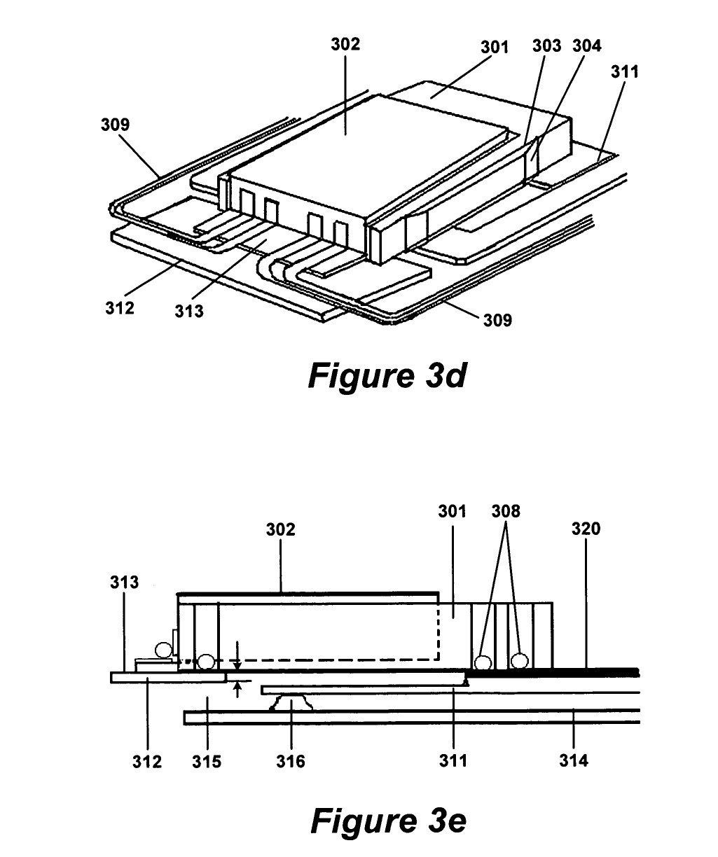

FIG. 3 shows an embodiment of the present invention. FIG. 3a shows a U shape micro actuator comprising two moving arms 303 and a base part 301. The base part 301 is partially potted to the point 320 of the suspension. A head slider 302 is coupled with the U-shape microactuator's moving arms 303 and support plate 8000 (refer to FIG. 3c and 3d) at their top ends 305 & 306. Two piezoelectric strips 304 are coupled with both of the moving arms 303 along the sides. The trailing edge of the head slider and the top ends of the moving arms are physically coupled with a moving plate 312. A bonding plate 313 is physically coupled with the moving plate 312. Four conductive balls (e.g., gold balls or solder balls) 307 electrically couple the head slider and head suspension to traces 309. Three conductive balls 308 (gold or solder balls) on both sides of the U-shape microactuator electrically couple the microactuator and the head suspension to traces 310. FIG. 3b shows a cross section view of FIG. 3a. FIG. 3c shows a detailed view of the apparatus without head 302. Support plate 8000 is used to adjust the slider's height because the thickness of support plate 8000 provides for any required of adjustment of height of head slider 302. The appropriate height of the slider is a height at which is able to at least read/write the data from/to a magnetic disk. Therefore, it is at least required to project the slider airbearing surface upward from the top surface of moving arms 303. The top surface of bonding plate 312 is level with support plate 8000, and the bonding plate 312 is flatly disposed side by side on the support plate 8000 and connects with the pad of the slider. The bonding plate 312 may also be inserted between the two top ends of the moving arms and sandwiched between the moving plate and the part of head slider. FIG. 3d shows the base part 301 of the U-shape microactuator situated partially on the predetermined position of the suspension tongue 311. The bonding plate includes traces 309 set on the moving plate to connect with the pad of head slider. FIG. 3e shows a profile view of the current embodiment where the head slider sits partially on the position 320 of suspension tongue 311. The suspension dimple 316 on a load beam 314 supports the suspension tongue. A parallel gap 315 exists between the suspension tongue and the bottom of the microactuator. This allows the microactuator to move smoothly, without interference, during voltage excitations. In this embodiment, support plate 8000 (the slider height adjuster) maintains the strength of micro-actuator by holding smaller sized sliders on the current micro-actuator even if the slider size is getting smaller.

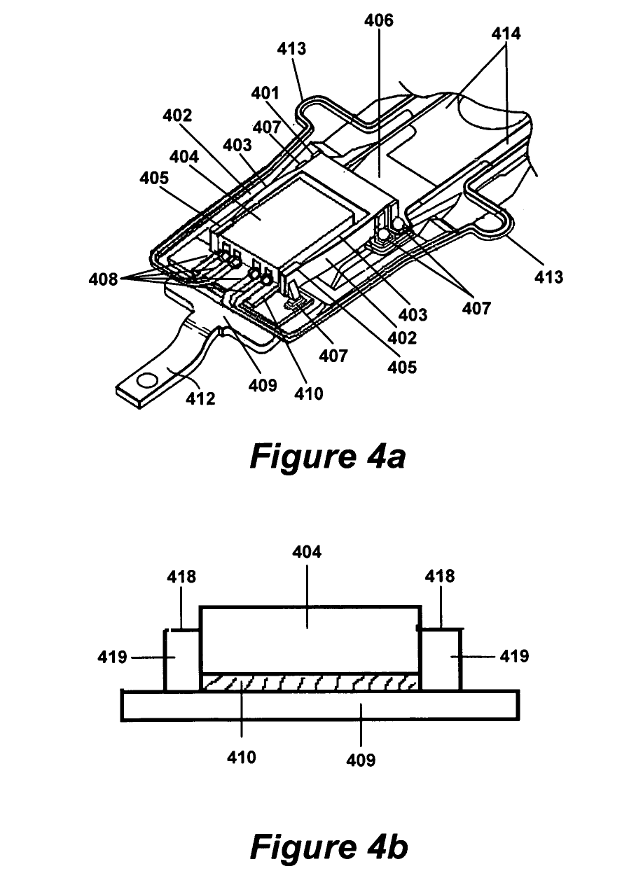

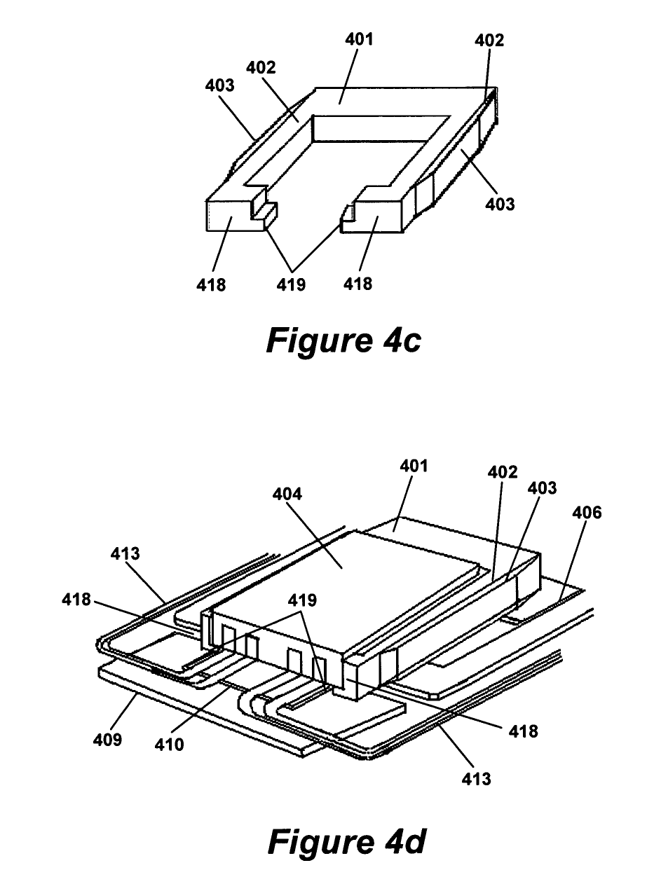

FIG. 4 shows another embodiment of this invention. FIG. 4a shows a U-shape microactuator comprising a base part 401 and two moving arms 402. The base part 401 of the microactuator is partially potted with the suspension tongue 406. A head slider 404 is coupled with the moving arms at the top end 418 on both sides (see FIG. 4b). Two piezoelectric strips 403 are coupled with the moving arms along the outside. The trailing edge of the head slider and the two moving arms of the microactuator are physically coupled with moving plate 409. Four conductive balls 408 (gold ball bonding or solder bump bonding) electrically couple the head slider 404 and the head suspension to traces 413. Three conductive balls 407 on both sides of the U-shape micro actuator electrically couple the microactuator and the head suspension to traces 414. FIG. 4b shows a cross section view. Bonding plate 410 is situated on the moving plate 409. Each of the moving arm ends of the micro actuator 401 has a side step 419 as a slider height adjuster. FIG. 4c shows the U-shape microactuator. In this embodiment, the side-step 419 on both ends of the arms 418 support the head slider. The height (thickness) of side-steps 419 operate to adjust the height of the head slider. This design allows smaller sized head sliders to be coupled to the current micro actuator and moving plate. FIG. 4d provides an additional detailed view of this embodiment of the invention detailing the aforementioned components. In this embodiment, side steps 419 (the slider height adjuster) maintain the strength of micro-actuator by holding smaller sized sliders on the current micro-actuator even if the slider size is getting smaller.

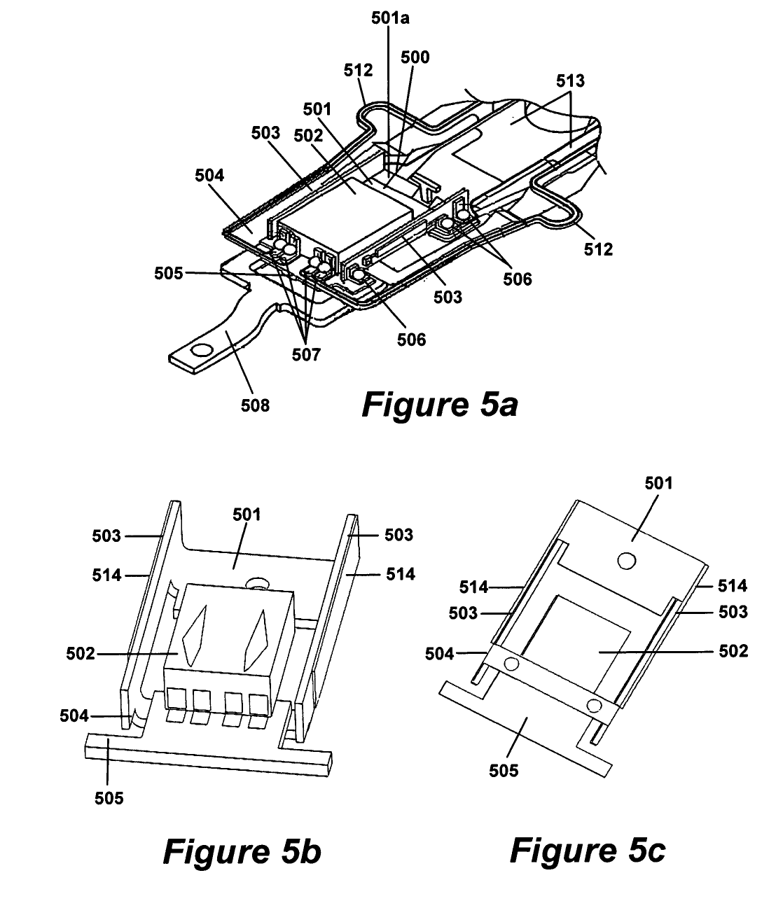

FIG. 5 shows another embodiment of the present invention. FIG. 5a shows a metal microactuator frame 500 comprising two moving arms 503 and a base part 501. The base part 501 is partially potted with a suspension tongue. A head slider 502 is coupled on the bottom side with support plate 504 that is further coupled to the moving arms 503. A piezoelectric strip 514 (refer to FIG. 5b) is coupled along the outside of each moving arm 503. The bonding plate 505 is sandwiched between the top arm and head slider 502. The slider's height is adjusted by the thickness of bonding plate 507. Four conductive balls 507 (gold ball or solder ball) electrically couple the head slider 502 and the head suspension to traces 512. Three conductive balls 506 on both sides of the microactuator electrically couple the microactuator and the head suspension to traces 513. FIG. 5b shows a detailed view the embodiment including the slider and the top arm. Using such a design allows smaller sized head sliders to be coupled to the current type of micro actuator. FIG. 5c shows a detailed bottom side view of the head slider coupled with the top arm. In this embodiment, bonding plate 505 (the slider height adjuster) maintains the strength of micro-actuator by holding smaller sized sliders on the current micro-actuator even if the slider size is getting smaller.

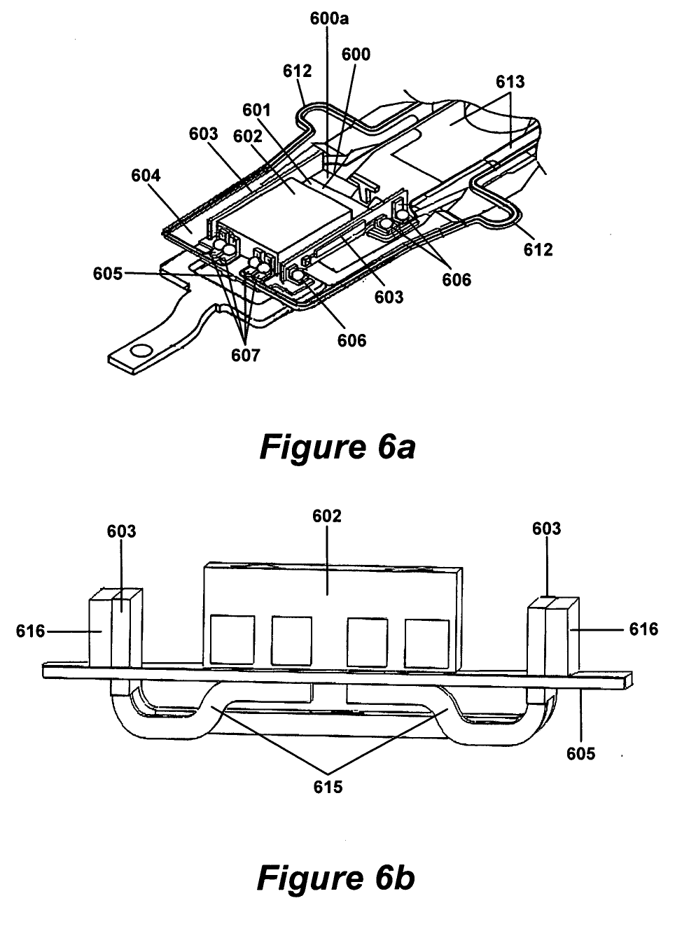

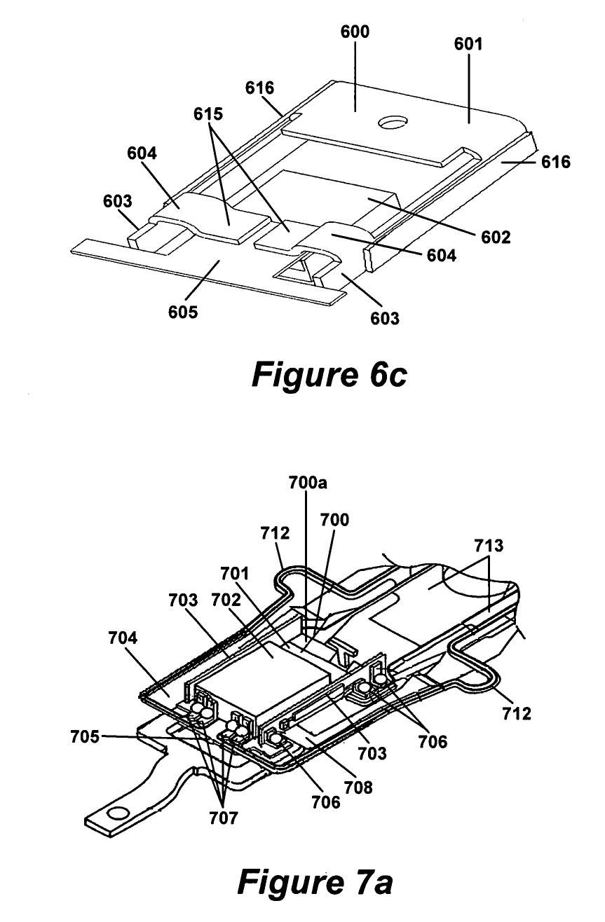

FIG. 6 shows another embodiment of the present invention with a metal microactuator frame 600 including a micro actuator comprising moving arms 603 and base part 601. The base part 601 is partially potted to the suspension tongue. A head slider 602 is coupled on its bottom side with a bonding plate 605 that is further coupled to top arm 604. The top arm 604 may be separated into two parts with each part having a forming step 615 (refer to FIG. 6c). A piezoelectric strips 616 is coupled along the outside of both the moving arms. Four conductive balls 607 (gold ball or solder ball) electrically couple the head slider and the suspension to traces 612. Three conductive balls 606 on both sides of the microactuator electrically couple the microactuator and the suspension to traces 613. FIG. 6b shows a side view of the head slider 602, the forming step 615 and the bonding 605 plate. FIG. 6c shows a bottom side view of the head slider 602, the forming step 615 and the bonding plate 605. In this embodiment, forming step 615 (the slider height adjuster) maintains the strength of microactuator by holding smaller sized sliders on the current microactuator even if the slider size is getting smaller. Using such a design allows smaller sized head sliders to be coupled to the current type of micro actuator.

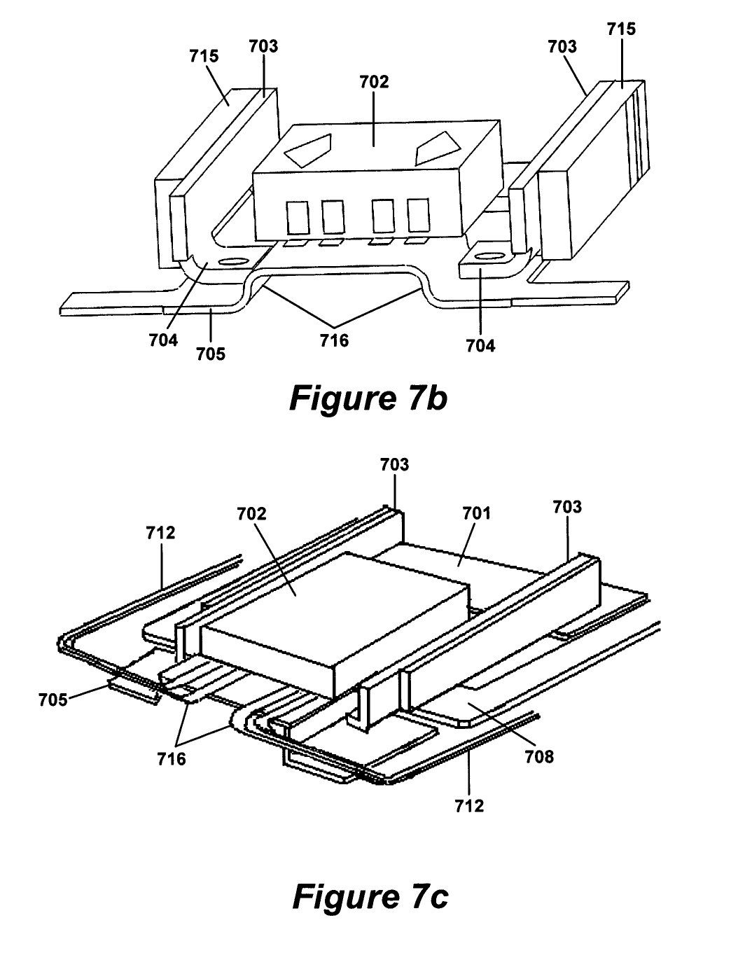

FIG. 7 shows another embodiment of the present invention. The microactuator includes two moving arms 703 and base part 701. The base part is partially potted with a suspension tongue. Piezoelectric strip 715 is coupled along the outside of each the moving arms of the micro actuator. The trailing edge of the head slider and the top arm of the microactuator are physically coupled with the bonding plate 705. Four conductive balls 707 (gold ball bonding or solder bump bonding) electrically couple the head slider and the suspension to traces 712. Three conductive balls 706 on both sides of the micro actuator electrically couple the micro actuator and the head suspension to traces 713. FIG. 7b shows another view the head slider coupled with bonding plate 705. The bonding plate has a forming step 716 in the position where the head slider rests allowing for the adjustment of the height of slider. The slider's height is adjusted by this height of forming step 716 disposed on the bonding plate 705. FIG. 7c shows an alternate view of the aforementioned microactuator and its peripheral. Using such a design allows smaller sized head sliders to be coupled to the same type of micro actuator. In this embodiment, forming step 716 (the slider height adjuster) maintains the strength of microactuator by holding smaller sized sliders on the current microactuator even if the slider size is getting smaller.

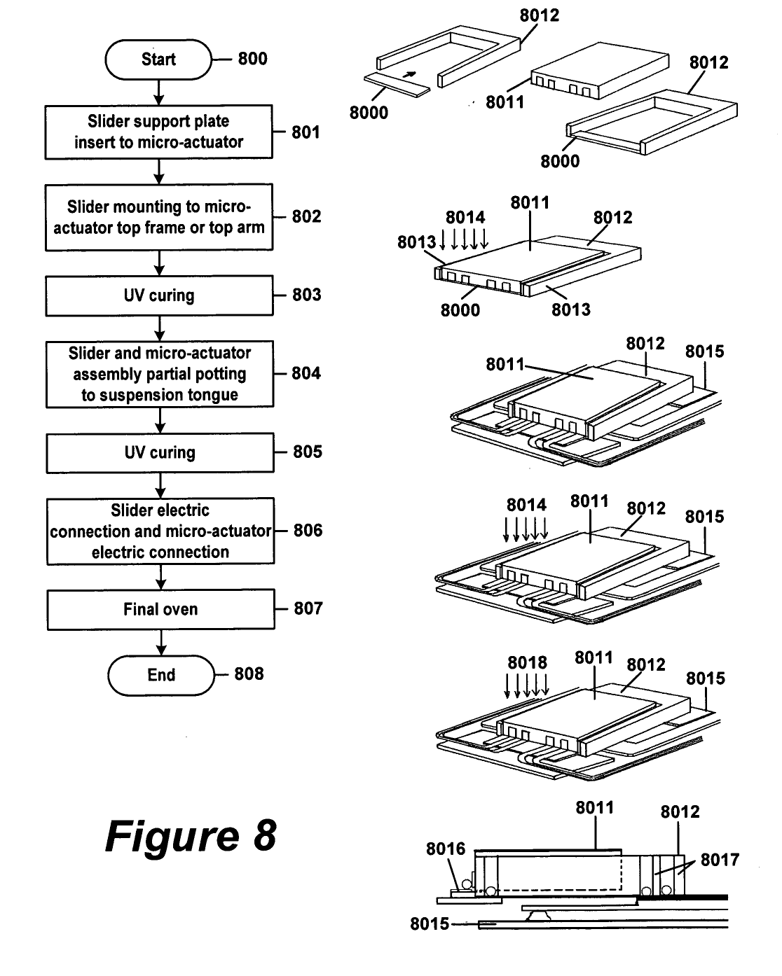

FIG. 8 shows a flowchart of an embodiment of a method of manufacturing a microactuator device according to an embodiment of the present invention. Starting from step 801, in step 802, the support plate 8000 is inserted in miroactuator 8012, and the slider 8011 is mounted to a top arm 8013 of the microactuator 8012 using an epoxy (not shown). In process 803, UV light 8014 cures the epoxy to fix the bond between the slider and micro actuator top arm. In step 804, the slider 8011 and micro actuator 8012 are partially mounted (potted) to the suspension 8015 using an epoxy (not shown). In step 805, the UV light 8014 cures the epoxy in order to affix the base part of the micro actuator and the suspension . In process 806, conductive balls 8016 are used to electrically connect the slider and suspension. Conductive balls 8017 are used to electrically couple the micro actuator and the suspension tongue. In step 807, an oven heater 8018 is used to help sufficiently cure the epoxy to ensure that the slider 8011, microactuator 8012 and suspension 8015 are sufficiently well-connected.

1-17. (canceled)

18. A magnetic disk drive, comprising:
a disk to which information is recorded;
a slider having a magnetic head to read/write information from/to said disk;
a suspension to support said slider, the suspension including a load beam being flexible in a direction substantially perpendicular to said disk;
a microactuator for micro motion of said slider disposed on said suspension;
a flexible printed circuit disposed on said suspension coupled to said slider;
two piezoelectric elements to be respectively attached to at least one moving arm; and
a slider height adjuster attached to said at least one moving arm to adjust the loading height of the slider wherein the microactuator further comprises a frame including a base attached to said suspension, and said at least one moving arm is attached parallel to said base.

19. The magnetic disk drive of claim 18, further comprising a moving plate coupled to a top end of said at least one moving arm and a bonding plate disposed on said moving plate having bonding pads to electrically connect with said slider and said flexible printed circuit.

20. The magnetic disk drive of claim 18, wherein said slider height adjuster adjusts the loading height of slider air bearing surface to project upward from the top surface of said frame.

21. The magnetic disk drive of claim 18, wherein said slider height adjuster comprises two side-steps attached to a top end of each of said at least one moving arm to hold the opposing surface of an air bearing surface of said slider; wherein said slider height adjuster has electrical pads attached to said flexible printed circuit and electrode pads of said slider.

22. The magnetic disk drive of claim 21, wherein said slider height adjuster further comprises a bonding plate disposed on said side-steps having bonding pads attached with said slider.

24. The magnetic disk drive of claim 21, wherein said side-steps are attached to each other.

25. The magnetic disk drive of claim 18, wherein said frame and said slider height adjuster are metal.

26. The magnetic disk drive of claim 22, wherein said side-steps and said bonding plate are seamless.

27. The magnetic disk drive of claim 18, wherein said slider height adjuster has electrical pads attached to said flexible printed circuit and electrode pads of said slider.

28. A magnetic disk drive of claim 18, wherein said slider height adjuster adjusts the loading height of said slider to project upward from the top surface of said frame.
